(19) United States
(12) Patent Application Publication
(10) Pub. No.: US 2011/0097684 A1
(43) Pub. Date: Apr. 28, 2011

(54) Biodegradable micro-applicator

(76) Inventor: Phillip Mark, Orlando, FL (US)

(21) Appl. No.: 12/589,352

(22) Filed: Oct. 22, 2009

(51) Int. Cl. A61C 5/00

(52) U.S. Cl. 433/80

(57) ABSTRACT

A disposable dental micro-applicator includes an elongated, rigid, biodegradable handle with first and second ends and an applicator mechanically fastened to the first end of the handle. The applicator includes a chemically resistant application tip.

### FIELD OF THE INVENTION

The invention relates to a dental applicator. More specifically, the invention relates to a disposable dental micro-applicator that is at least partially biodegradable.

### BACKGROUND OF THE INVENTION

Dental micro-applicators are designed to place controlled amounts of materials in hard-to-reach areas. Micro-applicators generally include a handle and a tip portion. In use, a user grips the handle portion and applies a material with the tip portion. For example, dental micro-applicators can be used to apply sealants, bonding agents, etchants, hemostatic solutions, cavity liners, disclosing solutions, etc. Some of these materials are caustic, and dissolve most plastics. Thus, micro-applicators made of chemically resistant materials were developed. Prior art micro-applicators were made of polypropylene, nylon, and other materials resistant to the chemical properties of the materials being applied. Typically, the entire micro-applicator is discarded after a single use. A standard dental procedure may require use of multiple micro-applicators, creating a sizeable amount of waste.

There is an increasing sensitivity to the amount of waste generated by human activities. As mentioned above, disposable micro-applicators contribute to excessive amounts of waste. Thus, micro-applicators with removable disposable tips were developed. Generally, the tip of a micro-applicator is significantly smaller in size compared to the handle portion. By creating disposable tips, it was thought the amount of waste created would be greatly decreased. Instead of disposing of an entire micro-applicator, a user could simply remove and dispose of the tip and be able to reuse the handle portion (after proper cleaning). However, this was not an adequate solution to the problem. Removing and replacing the disposable tips requires extra handling by users. Often times, to avoid the added time and effort required to remove and replace the tips, users discard the entire micro-applicator. Users are also concerned with cross-contamination between patients. Even though the tips can be removed and replaced, there is still the possibility that some contamination remains on the micro-applicator itself, even after proper cleaning. This also encourages users to simply discard entire micro-applicators after a single use.

Accordingly, there is a need for a disposable dental micro-applicator with less environmental impact. The present invention is provided to address this need, and to provide advantages and aspects not provided by known dental micro-applicators. A discussion of the features and advantages of the present invention is deferred to the following detailed description, which proceeds with reference to the accompanying drawings.

### SUMMARY OF THE INVENTION

The above and other needs are met by the disclosed embodiments which provide a biodegradable dental micro-applicator. The biodegradable dental micro-applicator includes an elongated, rigid, biodegradable handle. The micro-applicator further includes an applicator and a chemically resistant application tip. The applicator may be mechanically fastened to the handle.

Additional objects, advantages and novel features of these examples are set forth in the following description and drawings.

### BRIEF DESCRIPTION OF THE DRAWINGS

The drawing figures depict one or more implementations in accord with the present concepts, by way of example only, not by way of limitations.

FIG. 1 is a perspective view of a biodegradable micro-applicator.

FIG. 2 is an exploded perspective view of mating portions of a handle and an applicator.

FIG. 3 is an exploded perspective view of another set of mating portions of a handle and an applicator.

FIG. 4 is a perspective view of a biodegradable micro-applicator with an elongated tip.

FIG. 5 is a perspective view of a biodegradable micro-applicator with a bristle tip.

FIG. 6 is a perspective view of a biodegradable micro-applicator with a foam tip.

FIG. 7 is a perspective view of a biodegradable micro-applicator with a bamboo tip.

### DESCRIPTION OF THE PREFERRED EMBODIMENTS

It is contemplated that the subject matter described herein may be embodied in many forms. Accordingly, the embodiments described in detail below are the presently preferred embodiments, and are not to be considered limitations.

The disclosed embodiments address problems related to the volume of waste generated by disposable micro-applicators. The disclosed embodiments solve these problems, at least in part, by providing a micro-applicator that contains at least one portion made of biodegradable material.

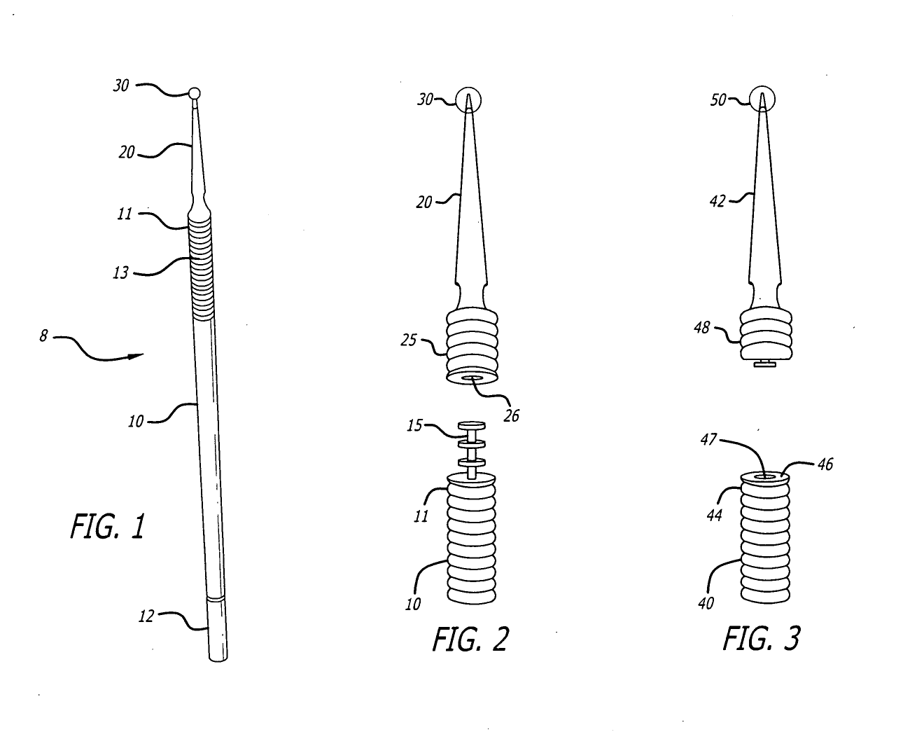

As shown in FIG. 1, a disposable dental micro-applicator 8 includes an elongated, rigid, biodegradable handle 10 and an applicator 20 having a first end 11 and a second end 12. The handle 10 may include a textured grip portion 13 which allows the user to more securely grasp the micro-applicator 8. A number of different biodegradable materials may be suitable for the handle 10, but preferably, the biodegradable handle 10 provides the handle with sufficient rigidity that a user can operate the applicator 8. For example, the biodegradable handle 10 may be comprised of resins derived from renewable resources.

As shown in FIG. 2, the first end 11 of the handle 10 includes a mating portion 15. The mating portion 15 shown in FIG. 2 is male in structure; however, other mating portion configurations are also contemplated. The applicator 20 also has a mating portion 25. The mating portion 15 of the handle 10 interacts with the mating portion 25 of the applicator 20 to mechanically fasten the applicator 20 to the handle 10. The mating portion 25 shown in FIG. 2 is female in structure, and has a hollow portion 26 such that it can receive the corresponding male mating portion 15. While mating portion 25 is shown in FIG. 2 as being female, other mating portion configurations are contemplated as well. The mating portions 15, 25 are mechanically fastened together such that the applicator 20 is securably attached to the handle 10. The mating portions 15, 25 may include features such as ribs, notches, threaded portions, etc., to improve the connection between the applicator 20 and the handle 10. The mating features may be, for example, overmolded on to the respective handle 10 or applicator 20.

The applicator 20 includes an application tip 30 that is resistant to degradation by the caustic compounds typically used in the field of dentistry. Examples of such chemically resistant materials include polypropylene and nylon. The application tip 30 may be bonded to the applicator 20, for example, with an epoxy resin. Alternatively, the application tip 30 may be detachable from the applicator 20.

The applicator 20 may further include biodegradable materials, chemically resistant materials, or both. Preferably, the material should exhibit enough elasticity such that the applicator 20 may flex but not break. For example, during use, it may be advantageous for a user to be able to flex the applicator 20 in order to reach hard-to-reach areas. Thus, flexibility in the applicator 20 may be desirable. The material of the applicator 20 should further exhibit properties that allow it to stay in a flexed configuration once manipulated by a user. In other words, the material should not exhibit memory properties such that it “snaps back” to its original shape. This will create a more user-friendly biodegradable micro-applicator.

The application tip 30 may be at least partially coated with an adhesive material such as dental glue. This would allow the user to use the micro-applicator 8 as a tool for picking up small or delicate items, such as a crown, veneer, band or bracket, to be placed in an area. For example, the user may pick up a small item by making contact with the item and the adhesive coated application tip 30. Once the user has placed the item in the desired location, the user may manipulate the biodegradable micro-applicator 8 in a way that releases the item from the application tip 30. Thus, the adhesive material should not be so strong that it permanently attaches to an item being picked up. It should only be as strong as is required to pick up an item and be able to release it without much force.

After use, the micro-applicator 8 may be disposed of without detaching the biodegradable handle 10. Alternatively, the biodegradable handle 10 may be removed from applicator 20 and disposed of separately. If the applicator 20 is removable from the handle 10, it is important that the force required to remove the applicator 20 be greater than the force required to flex the applicator 20. This will ensure that when the applicator 20 is flexed by a user, the applicator 20 does not become detached from the handle 10.

Another example of a mechanical connection between a handle 40 and an applicator 42 is shown in FIG. 3. A first end 44 of the handle 40 is shown as having a mating portion 46. The applicator 42 includes a mating portion 48 and a chemically resistant application tip 50. The mating portions 46, 48 may be mechanically fastened together such that the applicator 42 is securably attached to the handle 40. In FIG. 3, the mating portion 46 of the handle 40 is female and has a hollow portion 47. The mating portion 48 of the applicator 42 is male.

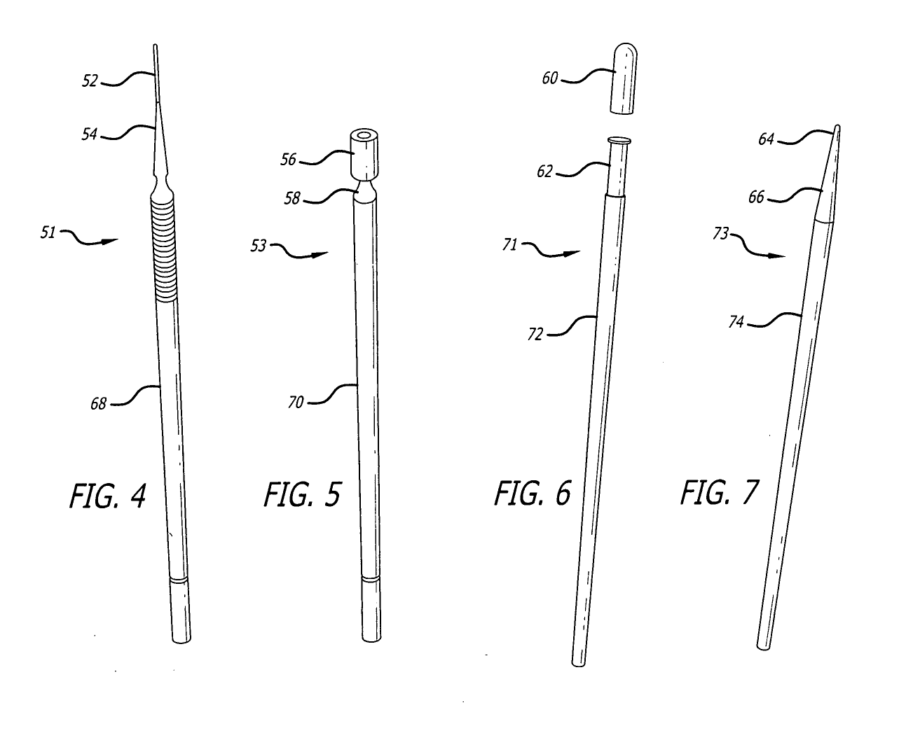

FIG. 4 shows a micro-applicator 51 with an elongated tip 52 attached to the end of an applicator 54. The elongated tip 52 may be mechanically connected to the applicator 54, and the applicator 54 may be mechanically fastened to a handle 68 in a manner similar to those described above with respect to FIG. 2 and FIG. 3. Thus, there may be two mechanical connections for this micro-applicator. Alternatively, the elongated tip 52 may be integrally formed with the applicator 54. The elongated tip 52 may also be connected to the applicator 54 with an epoxy resin such that it cannot be removed. The elongated tip 52 may be comprised of materials resistant to degradation caused by caustic compounds, such as nylon or polypropylene. It is not necessary that the applicator 54 be constructed from biodegradable materials, thus, it may also be constructed from materials resistant to degradation caused by caustic compounds. The handle 68 may be constructed from biodegradable materials, such as those described above with respect to the handle 10 of FIG. 1. The applicator 54 may also be constructed from biodegradable materials, such as the materials used to form the handle 68. The elongated tip 52 may be at least partially coated with an adhesive material such as dental glue. This would allow the user to use the micro-applicator as a tool for picking up small or delicate items, such as a crown, veneer, band or bracket, to be placed in a patient's mouth.

FIG. 5 shows a micro-applicator 53 with a bristled tip 56 attached to the end of an applicator 58, and the applicator 58 is mechanically fastened to a handle 70 in a manner described above. The bristled tip 56 may simply be fitted over the end of the applicator 58. The fit between the bristled tip 56 and the applicator 58 should be tight enough so as to securably connect the bristled tip 56 to the applicator 58. Other types of mechanical connections may also be used in order to secure the bristled tip 56 to the applicator 58. An epoxy resin or other adhesive may be used as well to secure the connection. The bristled tip 56 may allow the user to perform functions such as cleaning and polishing, or applying a material to an area.

FIG. 6 shows another example of a micro-applicator 71. The micro-applicator 71 has a foam tip 60 attached to the end of an applicator 62, and the applicator 62 is mechanically fastened to a handle 72. The foam tip 60 may be fitted over the end of the applicator 62 and securably connect it to the applicator 62. To create a secure connection, the fit between the foam tip 60 and the applicator 62 should be tight enough so that the foam tip 60 will remain in place during use. Other types of mechanical connections may be used as well. Alternatively, the foam tip 60 may be connected to the applicator 62 with use of an epoxy resin. The foam tip 60 may be at least partially coated with an adhesive material such as dental glue. This would allow a user to use the micro-applicator 71 as a tool for picking up small or delicate items, such as a crown, veneer, band or bracket to be placed in a patient's mouth.

FIG. 7 shows a micro-applicator 73 with a bamboo tip 64. The bamboo tip 64 may be attached to an applicator 66, and the applicator 66 is mechanically fastened to a handle 74. The bamboo tip 64 may be attached to the applicator 66 via a mechanical connection (as described above), or it may be integrally formed with the applicator 66. Further, the handle 74, applicator 66 and application tip 64 may all be formed from bamboo in order to decrease the manufacturing costs of working with a number of different materials. The handle 74, applicator 66 and application tip 64 may be integrally formed as well.

The foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the invention.

What is claimed is:

1. A disposable dental micro-applicator comprising:
an elongated handle, wherein the handle is comprised of a biodegradable material and includes at least a first end and second end; and
an applicator mechanically fastened to the first end of the handle, wherein the applicator includes a tip comprised of a chemically resistant material.

2. The disposable dental micro-applicator of claim 1, wherein the handle includes a textured grip portion.

3. The disposable dental micro-applicator of claim 1, wherein the applicator is also comprised of a biodegradable material.

4. The disposable dental micro-applicator of claim 1, wherein the applicator is comprised of a material selected from the group of nylon and polypropylene.

5. The disposable dental micro-applicator of claim 1, wherein the first end of the handle includes a mating portion, and the applicator includes a corresponding mating portion.

6. The disposable dental micro-applicator of claim 1, wherein the elongated biodegradable handle comprises bamboo.

7. The disposable dental micro-applicator of claim 1, wherein the chemically resistant application tip is selected from the group consisting of a bristled tip, foam tip, a micro-applicator tip, an elongated micro-applicator tip, and a bamboo tip.

8. The disposable dental micro-applicator of claim 1, wherein the chemically resistant application tip includes an adhesive.

9. The disposable dental micro-applicator of claim 1, wherein the chemically resistant application tip is detachable from the applicator.

10. A disposable dental micro-applicator comprising:
an elongated handle, wherein the handle includes at least a first end, the handle comprising a biodegradable material;
an applicator mechanically fastened to the first end of the handle, wherein the applicator includes a chemically resistant application tip.

11. The disposable dental micro-applicator of claim 10, wherein the handle includes a textured grip portion.

12. The disposable dental micro-applicator of claim 10, wherein the first end of the handle includes a mating portion, and the applicator includes a corresponding mating portion.

13. The disposable dental micro-applicator of claim 10, wherein the chemically resistant application tip is selected from the group consisting of a bristled tip, foam tip, a micro-applicator tip, an elongated micro-applicator tip, or a bamboo tip.

14. The disposable dental micro-applicator of claim 10, wherein the chemically resistant application tip includes an adhesive.

15. The disposable dental micro-applicator of claim 10, wherein the chemically resistant application tip is formed from a material selected from the group of nylon and polypropylene.

16. The disposable dental micro-applicator of claim 10, wherein the applicator is removable from the handle.

17. The disposable dental micro-applicator of claim 10, wherein the applicator is connected to the handle with an epoxy resin.
